(19) United States
(12) Patent Application Publication
(10) Pub. No.: US 2024/0292238 A1
(43) Pub. Date: Aug. 29, 2024

(54) SYSTEMS AND METHODS FOR ON/OFF STATUS CONTROL FOR NETWORK NODES

(71) Applicant: ZTE Corporation, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Jian LI, Shenzhen (CN)

(73) Assignee: ZTE Corporation, Shenzhen (CN)

(21) Appl. No.: 18/621,224

(22) Filed: Mar. 29, 2024

Related U.S. Application Data
(63) Continuation of application No. PCT/CN22/86760, filed on Apr. 14, 2022.

(51) Int. Cl. H04W 24/02; H04W 88/04

(52) U.S. Cl. CPC H04W 24/02; H04W 88/04

(57) ABSTRACT

Presented are systems and methods for on/off status control for network nodes. A network node can receive status indication information from a wireless communication node. The network node can determine, according to the status indication information, an on/off configuration of the network node to support signal forwarding of one or more signals between the wireless communication node and a wireless communication device.

### CROSS-REFERENCE TO RELATED APPLICATION

This application claims the benefit of priority under 35 U.S.C. § 120 as a continuation of International Patent Application No. PCT/CN2022/086760, filed on Apr. 14, 2022, the disclosure of which is incorporated herein by reference in its entirety.

### TECHNICAL FIELD

The disclosure relates generally to wireless communications, including but not limited to systems and methods for on/off status control for network nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can receive status indication information from a wireless communication node (e.g., base station (BS)). The network node can determine, according to the status indication information, an on/off configuration of the network node to support signal forwarding of one or more signals between the wireless communication node and a wireless communication device (e.g., user equipment (UE)).

In some implementations, the on/off configuration can comprise at least one of: an on/off configuration of the network node; an on/off configuration of a group of network nodes; an on/off configuration of one or more antenna ports of the network node; an on/off configuration of one or more beam indexes of the network node; an on/off configuration of one or more serving sectors of the network node; or an on/off configuration of one or more components of the network node. In some implementations, the on/off configuration may further comprise the on/off configuration of at least one of following links: a first communication link from a wireless communication node to the network node; a second communication link from the network node to the wireless communication node; a first forwarding link from the wireless communication node to the network node; a second forwarding link from the network node to the wireless communication node; a third forwarding link from the network node to the wireless communication device; or a fourth forwarding link from the wireless communication device to the network node.

In various implementations, the network node can receive the status indication information from the wireless communication node via a signaling. The signaling can comprise at least one of: downlink control information (DCI) or medium access control control element (MAC CE) signaling, radio resource control (RRC) or operations, administration and maintenance (OAM) signaling. In some cases, the network node can send a hybrid automatic repeat request acknowledgment (HARQ-ACK) feedback message to the wireless communication node, in response to receiving the status indication information.

In some implementations, on/off configuration of the network node can become active at a time instance. The time instance can comprise: a starting time of a next sub-frame; an end of a sub-frame in which the network node receives the status indication information; a starting time of a next frame; an end of a frame in which the network node receives the status indication information; a starting time of a sub-frame indicated by a system frame number (SFN) that is signaled together with the status indication information; a starting time of a frame indicated by a SFN that is signaled together with the status indication information; an end of system information (SI) window; a time instance at a defined duration after the network node receives the status indication information; a time instance at a first duration after the network node receives the status indication information, wherein the first duration is based on the network node's capability; or a time instance at a second duration after the network node receives the status indication information, wherein the second duration is configured via a signaling from the wireless communication node.

In some implementations, the status indication information can comprise a 1-bit indication, the 1-bit indication having a first value that indicates to activate the signal forwarding, or a second value that indicates to deactivate the signal forwarding. In some cases, a state of activation or deactivation of the signal forwarding can be maintained until a next 1-bit indication indicates a different state. In some cases, at least one of: a state of activation or deactivation of the signal forwarding can be configured to change to a previous state after a defined time has elapsed, or the defined duration can be configured via a DCI, MAC CE, radio resource control (RRC) or operations, administration and maintenance (OAM) signaling.

In some implementations, at least one of: the status indication information can comprise a value related to the transmission power control of the network node, if the value is at least one of: equal to or greater than a defined value, the value can indicate to activate the signal forwarding, or to deactivate the signal forwarding, or if the cumulated value related to the transmission power control of the network node by applying the value in status indication information is at least one of: equal to or greater than a defined value, the value or the cumulated value can indicate to activate the signal forwarding, or to deactivate the signal forwarding. In some cases, the defined value can be configured via a radio resource control (RRC), MAC CE, or operations, administration and maintenance (OAM) signaling. In some aspects, the value can be indicated by the transmit power control (TPC) field in a downlink control information (DCI)

### FIELD

In some implementations, a state of activation or deactivation of the signal is configured to change to a previous state after a defined time has elapsed, or the defined duration is configured via a downlink control information (DCI), medium access control control element (MAC CE), RRC or OAM signaling.

In various implementations, the status indication information can include at least one of: a duration indicating a first duration to activate the signal forwarding or to deactivate the signal forwarding, or a periodicity indicating to alternate between the first duration, and a second duration with a state of activation or deactivation of signal forwarding that is opposite that of the first duration, over time. In some cases, the status indication information can comprise at least one of: a ratio or percentage indicating a first duration to activate the signal forwarding and a second duration to deactivate the signal forwarding, or a periodicity indicating to alternate between the first duration and the second duration over time.

In some aspects, the periodicity can be activated at a reference time, or at the time instance. In some aspects, the status indication information can comprise a transmission pattern. In some implementations, the on/off configuration can be implicitly determined by a transmission pattern of at least one of a common signal or a common channel. In some implementations, the status indication information can comprise the implicit determination. In various implementations, at least one of: within a transmission pattern of a synchronization signal block (SSB) or a control resource set (CORESET) #0, at least one forwarding link may be activated; within a transmission pattern of a system information block (SIB) #1, at least one forwarding link may be activated; within a transmission pattern of a group common physical downlink control channel (PDCCH), at least one forwarding link may be activated; or within a transmission pattern of a physical random access channel (PRACH), at least one forwarding link may be activated.

In some implementations, the on/off configuration can be associated with a discontinuous reception mode. In some implementations, the status indication information can indicate a mode of discontinuous activation of the signal forwarding. In some cases, at least one of: a duration of a cycle for the mode of discontinuous activation of the signal forwarding, or a duration of an on state or an off state of the signal forwarding, may be configurable. In some implementations, the mode of discontinuous activation of the signal forwarding can be associated with a discontinuous reception mode.

In various implementations, the network node can receive a 1-bit indication when the network node is operating under the mode of discontinuous activation of the signal forwarding. The network node can determine to exit the mode of discontinuous activation of the signal forwarding, according to the 1-bit indication. In some aspects, at least one of: if the network node is supporting the signal forwarding when the 1-bit indication is received, the network node can continue to support the signal forwarding at least until a next 1-bit indication is received, or if the network node is not supporting the signal forwarding when the 1-bit indication is received, the network node can activate the signal forwarding at least until a next 1-bit indication is received.

In some implementations, the network node can receive a 1-bit indication and a duration when the network node is operating under the mode of discontinuous activation of the signal forwarding. The network node can determine, according to the 1-bit indication, to exit the mode of discontinuous activation of the signal forwarding in the duration, and to resume the mode of discontinuous activation of the signal forwarding when the duration ends. In various implementations, at least one of: if the network node is supporting the signal forwarding when the 1-bit indication is received, the network node can continue to support the signal forwarding for the duration, and resuming the mode of discontinuous activation of the signal forwarding when the duration ends, or if the network node is not supporting the signal forwarding when the 1-bit indication is received, the network node can activate the signal forwarding for the duration, and resuming the mode of discontinuous activation of the signal forwarding when the duration ends.

At least one aspect is directed to a system, method, apparatus, or a computer-readable medium. A wireless communication node can determine, according to a condition of the network node, an on/off configuration of the network node to support signal forwarding of one or more signals between the wireless communication node and a wireless communication device.

In some implementations, the condition of the network node can comprise at least one of: the network node is in a state prior to entering a radio resource control (RRC) connected state, the network node in a RRC idle or inactive state, unavailability of a qualified synchronization signal block (SSB), a random access failure, a look-before-talk failure, a radio link failure, a beam failure, or a defined threshold for number of re-transmissions is exceeded.

At least one aspect is directed to a system, method, apparatus, or a computer-readable medium. A wireless communication node can send status indication information to a network node, causing the network node to determine an on/off configuration of the network node to support signal forwarding of one or more signals between the wireless communication node and a wireless communication device, according to the status indication information.

The systems and methods presented herein include a novel approach for on/off status control for network nodes. Specifically, the systems and methods presented herein discuss a novel solution for using the network node (e.g., SN) to improve coverage of the network by various implementations of the on/off indication(s). The on/off indication can alleviate/minimize/reduce interference when/during communication between the wireless communication node (e.g., BS) and the wireless communication device (e.g., UE), and improve/enhance/increase energy efficiencies, such as when there is no communication (e.g., scheduled) between the wireless communication node and the wireless communication device.

For example, the wireless communication node can transmit/send/provide/broadcast an on/off status indication to at least one network node. The status of the network node can be determined according to the indication. After/subsequent to the network node receiving the on/off indication, the status of the network node can be changed based on or according to the epoch time (e.g., sometimes labeled as “t”). The on/off indication can include at least one of: 1-bit explicit indication, implicit indication by re-interpreting an existing DCI field, a duration, a periodicity, a percentage, an explicit on/off pattern, and/or an implicit on/off pattern, among other types of indication. The different/varying combinations of these on/off indications, and the associated or corresponding methods or implementations for providing the indication(s), can comprise at least the following options or operations:
Option 1: 1-bit explicit indication;
Option 2: implicit indication by re-interpreting existing DCI field;
Option 3: 1-bit explicit indication and a duration;
Option 4: implicit indication and a duration;
Option 5: a periodicity and a duration;
Option 6: a periodicity and a percentage;
Option 7: an explicit on/off pattern indication;
Option 8: an implicit on/off pattern indication;
Option 9: a discontinuous forwarding (DF) mode; and/or
Option 10: on/off status determined by the condition of SN.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates a tree diagram of various options for the on/off status indication, in accordance with some embodiments of the present disclosure;

FIG. 6 illustrates an example of certain options for dynamic indication, in accordance with some embodiments of the present disclosure;

FIG. 7 illustrates an example of certain other options for dynamic indication, in accordance with some embodiments of the present disclosure;

FIG. 8 illustrates an example of certain options for static indication, in accordance with some embodiments of the present disclosure;

FIG. 9 illustrates an example of certain options for pattern-based indication, in accordance with some embodiments of the present disclosure;

FIG. 10 illustrates an example of another option for pattern-based indication, in accordance with some embodiments of the present disclosure;

FIG. 11 illustrates an example of a combination of options 1 and 9 for the on/off indication, in accordance with some embodiments of the present disclosure;

FIG. 12 illustrates an example of a combination of options 3 and 9 for the on/off indication, in accordance with some embodiments of the present disclosure; and

FIG. 13 illustrates a flow diagram of an example method for on/off status control for network nodes, in accordance with an embodiment of the present disclosure.

### DETAILED DESCRIPTION

### 1. Mobile Communication Technology and Environment

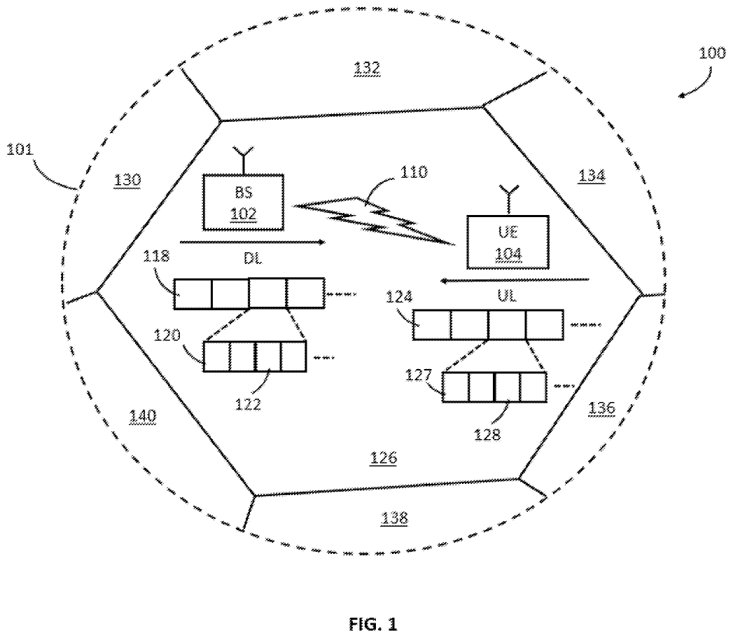

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

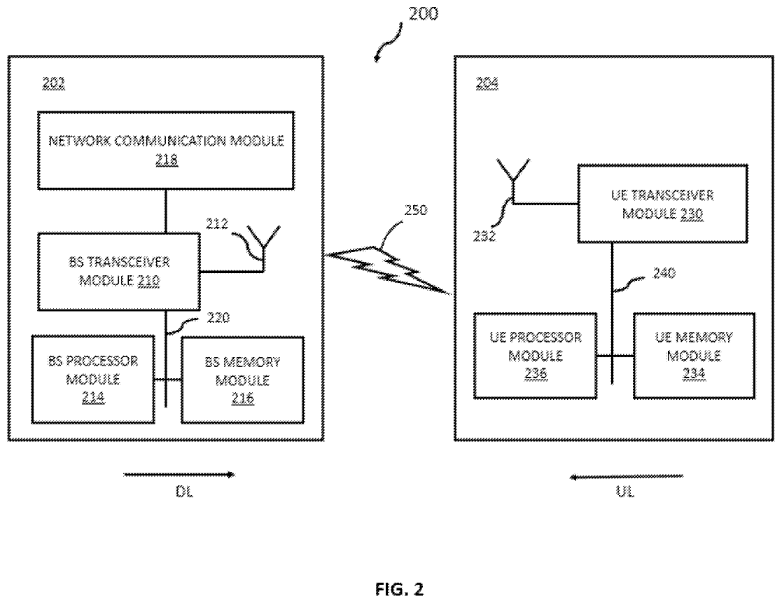

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for On/Off Status Control for Network Nodes

In certain systems (e.g., 5G new radio (NR), Next Generation (NG) systems, 3GPP systems, and/or other systems), a network-controlled repeater can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The network-controlled repeater can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, Re-configuration intelligent surface (RIS), Integrated Access and Backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.). However, due to the SNs not being aware of other SNs, the UE 104 may suffer from interference from other SNs, such as for cell-edge UEs.

To mitigate/minimize/reduce the (e.g., unexpected) interference from other SNs, the systems and methods of the technical solution discussed herein can introduce/provide/leverage an on/off status control. With the on/off status control, the network (e.g., the BS 102) can explicitly or implicitly indicate/provide the on/off status/indication for one or more SNs, thereby alleviating the potential impact of interference during communication between the BS 102 and the UE 104 through one or more SNs (e.g., network nodes).

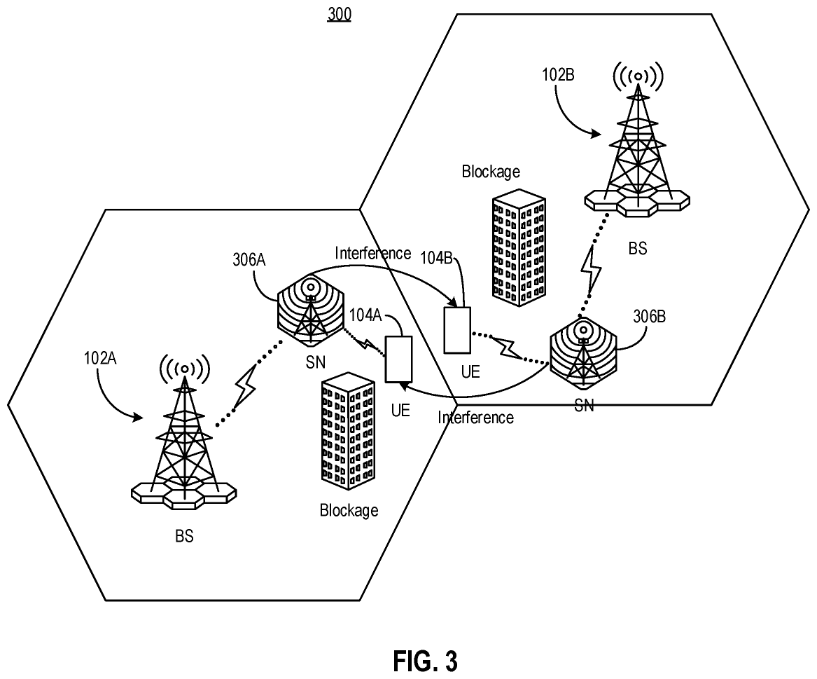

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 306A-B (e.g., sometimes labeled as SN(s) 306), such as when there are blockages between the BS(s) 102 and the UE(s) 104. However, in some cases, the signals from an SN 306 may interfere with the communications in an adjacent cell. For example, signals from SN 306A may interfere with the communications in the cell associated with UE 104B, and/or signals from SN 306B may interfere with the communications in the cell associated with UE 104A. As such, the systems and methods discussed herein can utilize the on/off status control for the SNs to minimize at least the interferences by the signals of the SNs 306 between different cells.

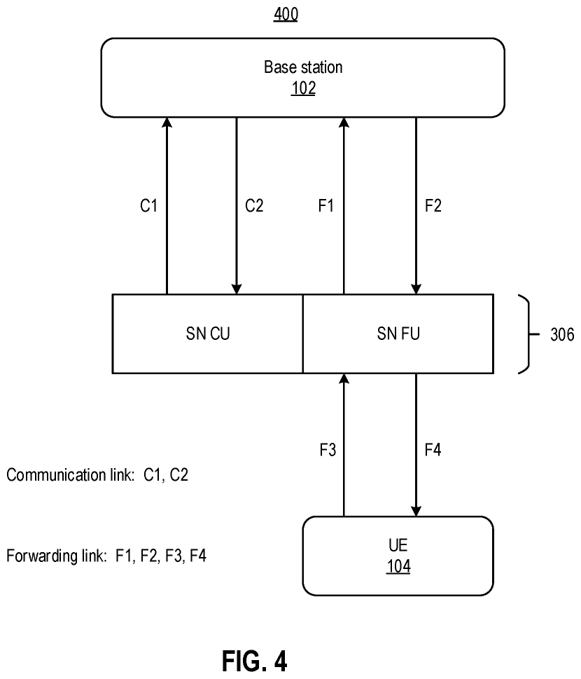

FIG. 4 illustrates a schematic diagram 400 of transmission links between BS 102 to SN 306 and SN 306 to UE 104. The SN can include or consist of at least two functional parts/components, such as the communication unit (CU) (e.g., SN CU) and the forwarding unit (FU) (e.g., SN FU). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Communication link from SN CU to BS;
C2: Communication link from BS to SN CU;
F1: Forwarding link from SN FU to BS;
F2: Forwarding link from BS to SN FU;
F3: Forwarding link from UE to SN FU; and
F4: Forwarding link from SN FU to UE.

Communication link can refer to or mean that the signal from one side will be detected and decoded by the other side, so that the information transmitting in the communication link can be utilized to control the status of forwarding links. Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link from UE 104 to BS 102, in which F1 is the SN FU UL forwarding link. Additionally, the F2 and F4 links can correspond to or be associated with the complete DL forwarding link from BS 102 to UE 104, in which F4 is the SN FU DL forwarding link.

The on/off operation or indication from the BS 102 can include/have different granularities, such as including at least one of the following cases:

### 1. Per SN:

In some implementations, the BS 102 can indicate the on/off signaling (e.g., signal the SN 306) to turn on/off one or more SNs 306 (e.g., the forwarding functionality). In some cases, the BS 102 may indicate the on/off signaling to turn on/off one or more groups of SNs 306.

### 2. Per Link or Combination(s) of Links (e.g., May be Based on the Definition of the Link):

In various implementations, the on/off status can correspond to or be indicated for UL forwarding link(s), such as F1 and/or F3. For example, when the UL forwarding link F1 is “off”, the SN FU may only disable the transmitting operation, but the SN FU may receive and process the received signals (e.g., signals from the UE 104). In some cases, when the UL forwarding links F1 and F3 (e.g., F1+F3) are “off”, the SN FU can disable both the transmitting and receiving operations (e.g., UL transmissions from the UE 104 to the SN FU and the SN FU to the BS 102 can be disabled).

In some implementations, the on/off status can correspond to downlink (DL) forwarding link(s) F4 or F2+F4. For example, when the DL forwarding link F4 is “off”, the SN FU may only disable the transmitting operation, but the SN FU may receive and process the received signals from the BS 102. Further, when the DL forwarding links F2 and F4 are “off”, the SN FU can disable both the transmitting and receiving operations.

In some aspects, the on/off status can correspond to the UL and DL forwarding links, such as F1+F4 or F1+F2+F3+F4. For example, when the forwarding links F1+F4 are “off”, the SN FU may only disable the transmitting operation, but it may receive and process the received signals, such as from at least one of the BS 102 or the UE 104. Additionally or alternatively, when the DL forwarding links F1+F2+F3+F4 are “off”, the SN FU can disable both the transmitting and receiving operations of all the forwarding links shown in FIG. 4. Other combinations of enabling or disabling (e.g., on/off status for individual links) can be indicated by the BS 102.

### 3. Per Part of a Link:

In various implementations, the on/off status corresponds to antenna port. For example, SN FU may have several antenna ports, and status information may indicate the status of at least one of these antenna ports. In some cases, the on/off status can correspond to a beam index. For example, SN FU may include or be associated with several beams. The status information may indicate the status of at least one of the beams, including disabling part of beam (e.g., such functionality can also be achieved according to the reconfiguration of beam/TCI information).

In some aspects, the on/off status can correspond to sectors. For example, similar to BS sectors (e.g., gNB sectors), SN 306 may serve UEs 104 from different sectors. Each sector can cover a region of serving area.

### 4. Per FU Component:

In some implementations, the on/off status can be related to the circuit or hardware design of the SN FU. The status information may indicate the status of at least one of these FU components (e.g., the circuit or hardware). For instance, if the SN 306 is a RIS, the FU component of the SN 306 may be RIS component, RIS panel, amplitude, phase, among others.

### 5. Per Functionality or Combination(s) of Functionalities:

In various implementations, the signaling forwarding can be regarded as, referred to, or interpreted as forwarding link and/or forwarding functionality. The on/off status can be applied on the functionality of the SN 306. For example, the on/off status can be applied to at least one of the communication functionality and/or forwarding functionality. Similar to per link or link combinations granularity, the functionality can be divided/separated as follows:
Cf1: communication functionality from SN CU to BS 102;
Cf2: communication functionality from BS 102 to SN CU;
Ff1: forwarding functionality from SN FU to BS 102;
Ff2: forwarding functionality from BS 102 to SN FU;
Ff3: forwarding functionality from UE 104 to SN FU; and/or
Ff4: forwarding functionality from SN FU to UE 104.

Similar to per link and/or combination(s) of links, and in various implementations, the on/off status can correspond to or be indicated for UL forwarding functionality(s), such as Ff1 and/or Ff3. For example, when the UL forwarding functionality Ff1 is “off”/deactivated, the SN FU may only disable the transmitting operation, but the SN FU may receive and process the received signals (e.g., signals from the UE 104). In some cases, when the UL forwarding functionality Ff1 and Ff3 (e.g., Ff1+Ff3) are “off”, the SN FU can disable both the transmitting and receiving operations (e.g., UL transmissions from the UE 104 to the SN FU and the SN FU to the BS 102 can be disabled), for example.

In some implementations, the on/off status can correspond to DL forwarding link(s) Ff4 or Ff2+Ff4. For example, when the DL forwarding link Ff4 is “off”, the SN FU may only disable the transmitting operation, but the SN FU may receive and process the received signals from the BS 102. Further, when the DL forwarding links Ff2 and Ff4 are “off”, the SN FU can disable both the transmitting and receiving operations.

In some aspects, the on/off status can correspond to the UL and DL forwarding links, such as Ff1+Ff4 or Ff1+Ff2+Ff3+Ff4. For example, when the forwarding links Ff1+Ff4 are “off”, the SN FU may only disable the transmitting operation, but it may receive and process the received signals, such as from at least one of the BS 102 or the UE 104. Additionally or alternatively, when the DL forwarding links Ff1+Ff2+Ff3+Ff4 are “off”, the SN FU can disable both the transmitting and receiving operations of all the forwarding links. Other combinations of enabling or disabling (e.g., on/off status for individual links) can be indicated by the BS 102.

Example Implementation: BS Transmits Status Indication (e.g., on/Off) to SN, and the Status (e.g. on/Off) of SN is Determined According to the Indication

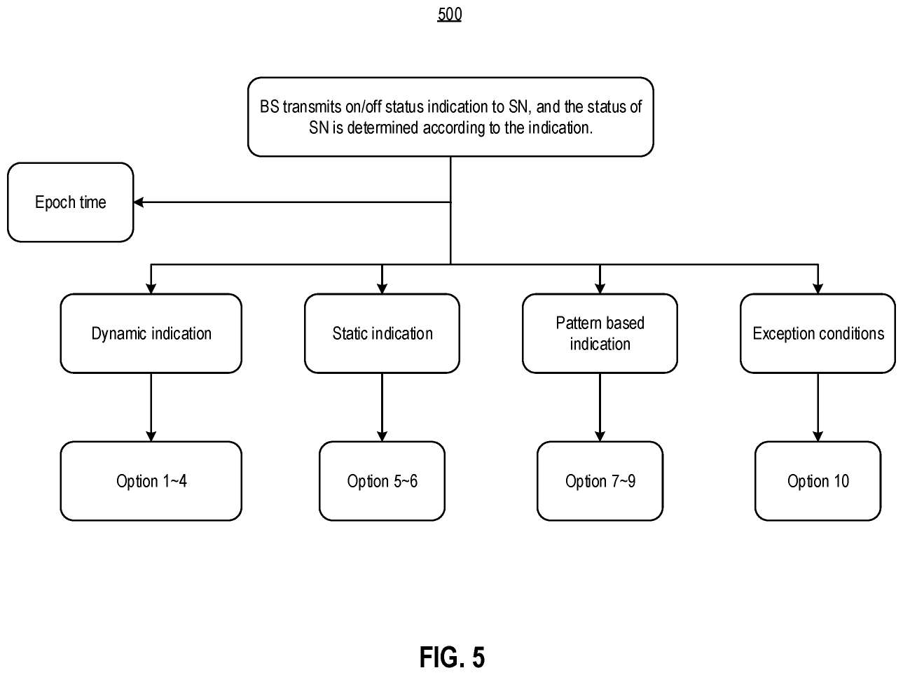

Referring to FIG. 5, depicted is a schematic diagram 500 of an example network. As shown, the BS 102 can transmit a status indication (e.g., on/off and/or power control value) to one or more SN 306. The status of the SN 306 can be determined according to the indication from the BS 102. For example, the SN 306 can receive/obtain/acquire the on/off indication (e.g., signaling) from the BS 102. After the SN 306 receives the on/off indication, the SN 306 can determine a pattern of on/off state/status for at least one link (e.g., forwarding link) for forwarding signals between the BS 102 and the UE 104. As such, the status of SN 306 can be changed responsive to or based on the epoch time. The epoch time can include, but is not limited to, at least one of:
Starting time of next sub-frame;
End of the sub-frame in which or where the SN 306 receives the status indication information (e.g., on/off indication);
Starting time of a next frame;
End of the frame in which the SN 306 receives the status indication information;
Starting time of the sub-frame, indicated by a system frame number (SFN) and/or a sub-frame number signaled together with the status indication information;
Starting time of a frame, indicated by a SFN that is signaled together with the status indication information;
End of system information (SI) window;
After a fixed time duration between or a time instance at a defined duration after the SN 306 receives the status indication information and/or epoch time in the specification (e.g., configuration), which can be at least one of symbol level, slot level, or ms level;
After a time duration between (e.g., a time instance at a first duration after) SN 306 receives the status indication information and/or epoch time based on the capability of the SN 306; and/or
After a time duration between (e.g., a time instance at a second duration after) SN 306 receives the status indication information and/or epoch time which is configured by the BS 102 through/via at least one of the signalings from the BS 102, such as operations, administration and maintenance (OAM) signaling, radio resource control (RRC), medium access control control element (MAC CE), and/or downlink control information (DCI).

As discussed herein, the relationship between indication reception time and epoch time may not be explicitly illustrated, and the arrow pointers can indicate the exact time when SN 306 changes its status (e.g., epoch time). For instance, the epoch time can indicate or represent time instance(s) when the status of the SN 306 changes from on to off or off to on.

The on/off indication (e.g., status indication information) can include at least one of 1-bit explicit indication, implicit indication by re-interpreting an existing DCI field, a duration, a periodicity, a percentage, an explicit on/off pattern, and/or an implicit on/off pattern, among others. As shown in FIG. 5, the different combinations of the on/off indications, and the corresponding operations, can be provided or implemented based on one or more of the options. For example, options 1-4 can be associated with the dynamic indication, options 5-6 can be associated with the static indication, options 7-9 can be associated with pattern-based indication, and option 10 (e.g., among other options) can be associated with certain exceptional conditions, such as discussed herein. In some cases, the options of on/off control or indication operations can be jointly used.

### Example Options for Dynamic Indication

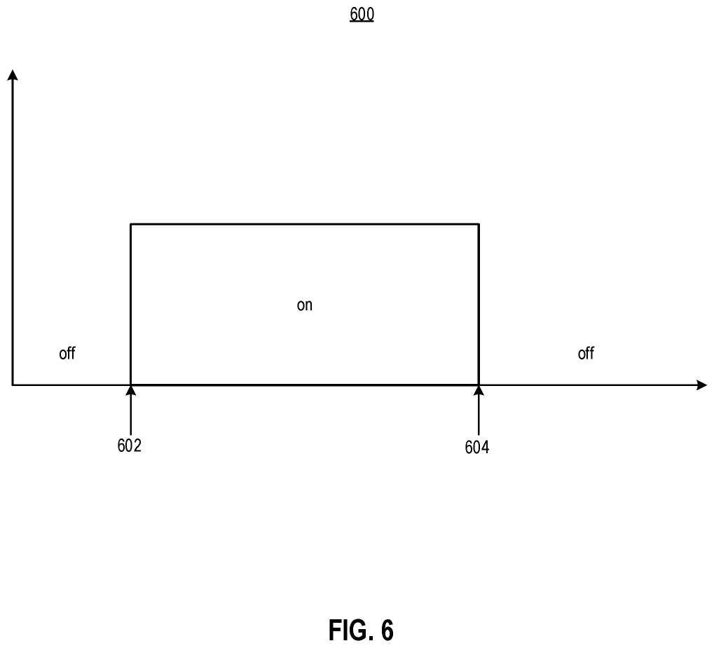

Referring to FIG. 6, depicted is an example 600 of certain options for dynamic indication. For example, option 1 for the dynamic indication can include or correspond to a 1-bit explicit indication. The BS 102 can transmit/send/provide/indicate/signal the status indication information (e.g., on/off indication) including a 1-bit explicit indication to the SN 306 (e.g., SN CU). The 1-bit indication can be provided via at least one of the DCI, MAC CE, and/or RRC. The 1-bit indication can have or include a first value (e.g., on indication) that indicates to activate the signal forwarding, or a second value (e.g., off indication) that indicates to deactivate the signal forwarding. For instance, bit 1 can indicate “on” (e.g., provided at time instance 602) and bit 0 can indicate “off” (e.g., provided at time instance 604), or vice versa. In this case, the on/off status (e.g., state of activation or deactivation of the signal forwarding) can remain the same or be maintained by the SN 306 until the next 1-bit indication is received, indicating a different state. In some cases, if the signal is provided via DCI, a new DCI field may be defined or configured, such as an on/off status field.

In another example, option 2 can include an implicit indication determined by a power control value or a value related to transmission power control of SN 306 (e.g., TCP command, etc.). The power control value(s) can correspond to at least one of an absolute power control value (e.g., this value can be exactly the power used by the SN FU) and/or the deviation of the power control value (e.g., the deviation value can be added on SN FU's current power, the cumulated value can be the transmit power of SN FU). The power control value can include at least one of a value of the DCI field, a RRC parameter, and/or MAC CE. The DCI field can be re-interpreting a TPC command field or defining a new DCI field of power control value for SN 306. For instance, if the power control value (e.g., the value of the DCI field) or the cumulated power control value (e.g. the value of the DCI field added by SN FU's current power) is greater than or equal to the predefined/predetermined value X, the power control value or the cumulated power control value can indicate to activate the signal forwarding. Otherwise, the power control value or the cumulated power control value can indicate to deactivate the signal forwarding. The predefined value X can be predefined/configured/preset through/via RRC or OAM signaling.

In some cases, the predefined value X can be provided/fixed in the specification. In some cases, the predefined value X can be 0, if the power control value (e.g., the value of the DCI field) or the cumulated power control value (e.g., the value of the DCI field added by SN FU's current power) is 0, the power control value or the cumulated power control value can indicate to deactivate the signal forwarding. Otherwise, the power control value or the cumulated power control value can indicate to activate the signal forwarding. The state of activation or deactivation of the forwarding signal can be maintained until the SN 306 receives the next indication indicating a different state.

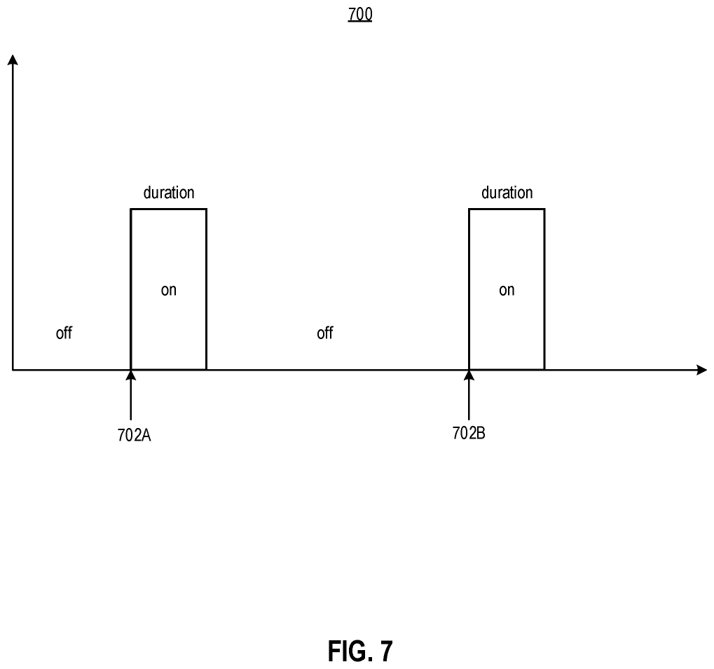

FIG. 7 illustrates an example 700 of certain other options for dynamic indication. Referring to option 3, the BS 102 can provide a 1-bit explicit indication and a duration to the SN 306, such as to enable or disable the forwarding signal responsive to receiving the indication and reverts to the previous state subsequent to the duration. For example, the BS 102 can provide the 1-bit indication via DCI, MAC CE, and/or RRC. The bit 1 can indicate an on/enable/activation state and the bit 0 can indicate an off/disable/deactivation state. Responsive to receiving/acquiring the indication (e.g., at 702A or 702B), the SN 306 can change its state (or maintained the same state) based on the provided 1-bit indication. Further, the SN 306 can receive a predetermined/defined duration “t” via the DCI, MAC CE, RRC, and/or OAM signaling. The SN 306 can receive the duration t, prior, simultaneously, or subsequent to the 1-bit indication. Accordingly, after maintaining the state (e.g., activation state) based on the indication, the on/off status of the SN 306 can revert/change/alter to the other state (e.g., deactivation state) before the 1-bit indication after duration t. In some cases, the SN 306 can receive the 1-bit indication for deactivation. As such, the SN 306 can reactivate after the duration t. The duration t can correspond to at least one of symbol level, slot level, and/or ms level, among others.

Referring to option 4, the BS 102 can provide an implicit indication (e.g., implicit status indication information) and duration to the SN 306. The implicit indication can be similar to the implicit indication as in option 2.

For example, the implicit indication can be determined by a power control value or a value related to transmission power control of SN 306 (e.g., TCP command, etc.). The power control value(s) can correspond to at least one of an absolute power control value (e.g., this value can be exactly the power used by the SN FU) and/or the deviation of the power control value (e.g., the deviation value can be added on SN FU's current power, the cumulated value can be the transmit power of SN FU). The power control value can include at least one of a value of the DCI field, a RRC parameter, and/or MAC CE. The DCI field can be re-interpreting a TPC command field or defining a new DCI field of power control value for SN 306. For instance, if the power control value (e.g., the value of the DCI field) or the cumulated power control value (e.g. the value of the DCI field added by SN FU's current power) is greater than or equal to the predefined/predetermined value X, the power control value or the cumulated power control value can indicate to activate the signal forwarding. Otherwise, the power control value or the cumulated power control value can indicate to deactivate the signal forwarding. The predefined value X can be predefined/configured/preset through/via RRC or OAM signaling.

In some cases, the predefined value X can be provided/fixed in the specification. In some cases, the predefined value X can be 0, if the power control value (e.g., the value of the DCI field) or the cumulated power control value (e.g., the value of the DCI field added by SN FU's current power) is 0, the power control value or the cumulated power control value can indicate to deactivate the signal forwarding. Otherwise, the power control value or the cumulated power control value can indicate to activate the signal forwarding. The state of activation or deactivation of the forwarding signal can be maintained until the SN 306 receives the next indication indicating a different state.

Further, the SN 306 can change the on/off status changes to the previous status before the implicit indication after duration t. The duration t can be configured through at least one of RRC, OAM, MAC CE, and/or DCI. The duration t can correspond to at least one of symbol level, slot level, and/or ms level, among others.

### Example Options for Static Indication

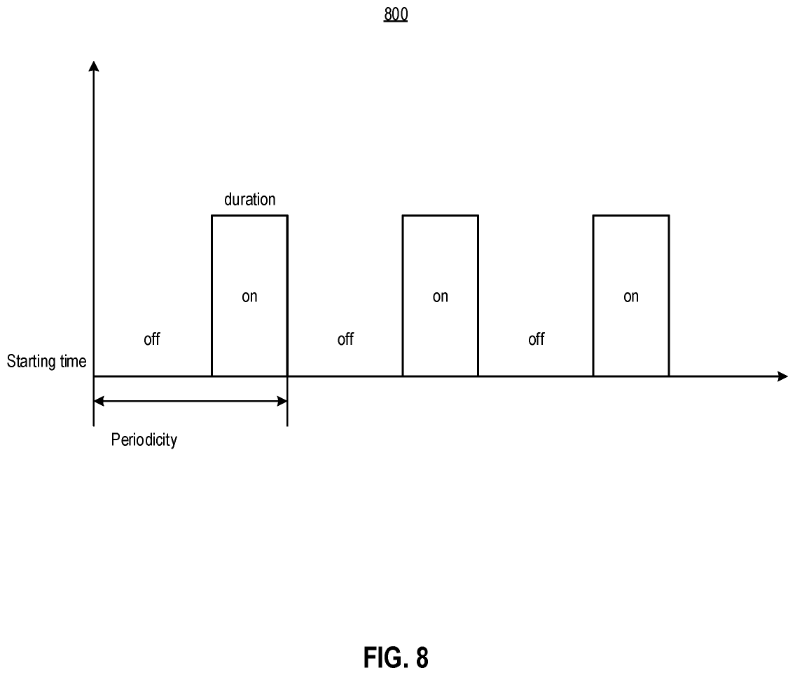

FIG. 8 illustrates an example 800 of certain options for static indication. Referring to option 5, the BS 102 can provide the status indication information including at least one of a periodicity and/or duration to the SN 306. For example, the BS 102 can configure the periodicity and/or duration via the RRC, OAM, MAC CE, and/or DCI. The periodicity can include multiple parts, such as a status “on” pattern/part and a status “off” pattern. The on/off pattern can be repeated until the SN 306 receives the next status indication information (e.g., having a different pattern). The on/off pattern in each periodicity, e.g., on prior to off or off prior to off, can be allowed.

In further example, the BS 102 can provide, to the SN 306, a duration indicating a first duration to activate the signal forwarding or to deactivate the signal forwarding. The BS 102 can provide, to the SN 306, a periodicity indicating to alternate between the first duration (e.g., to turn on or off) and a second duration with the state of activation or deactivation of the signal forwarding opposite of the first duration over time. In this case, if the first duration indicates an “on” state, the second duration can indicate the state of deactivation or “off” state, and vice versa.

The starting time of the periodic on/off pattern can correspond to the epoch time defined, such as described in FIG. 5, or (e.g., fixed/predefined/configured) reference time, e.g., SFN0 (e.g., system frame number 0), etc. For instance, the periodicity of the pattern can be activated at the reference time or at the time instance according to at least one epoch time. The duration can be defined as the duration or period of time to maintain the “on” status or “off” status. The duration t can correspond to at least one of symbol level, slot level, and/or ms level.

Referring to option 6, the BS 102 can provide a status indication information including at least a periodicity and a percentage to the SN 306. The BS 102 can configure the periodicity and percentage via at least one of the RRC, OAM signaling, MAC CE, and/or DCI. The periodicity can include, indicate, or be associated with an on/off pattern (e.g., status “on” part and status “off” part). The on/off pattern may be repeated until the SN 306 receives the next status indication information (e.g., different on/off indication or pattern). The repetition can be initiated at the end of the period, for example. The on/off pattern in each periodicity can be allowed, such as on prior to off or off prior to off. The starting time of the periodic on/off pattern can correspond to the epoch time (e.g., one of the types of epoch time), or a fixed reference time, such as SFN0, etc.

In various implementations, the status indication information can include a ratio or percentage indicating the percentage (e.g., a duration) of “on” status or “off” status. For example, if the ratio is 1/3 “on”, the SN 306 can be activated 1/3 of the total time in each periodicity and deactivated 2/3 of the total time in each periodicity. As such, the periodicity can indicate to alternate between the activation duration and the deactivation duration. Any activation or deactivation pattern can be used for turning on or off the SN 306 according to the ratio. For example, as shown in FIG. 8, the SN 306 can turn on at the last 1/3 time duration of the periodicity. In some cases, the SN 306 can burn on at the start of the periodicity or at the 2/3 time duration within the periodicity. In some cases, the SN 306 can turn on and off multiple times at any time instances within the periodicity based on the ratio/percentage. For instance, the SN 306 can turn on at a first duration, turn off at a second duration, turn on at a third duration, and turn off at a fourth duration. The first and third durations can correspond to the 1/3 ratio, and the second and fourth durations can correspond to the 2/3 ratio.

### Example Options for Pattern-Based Indication

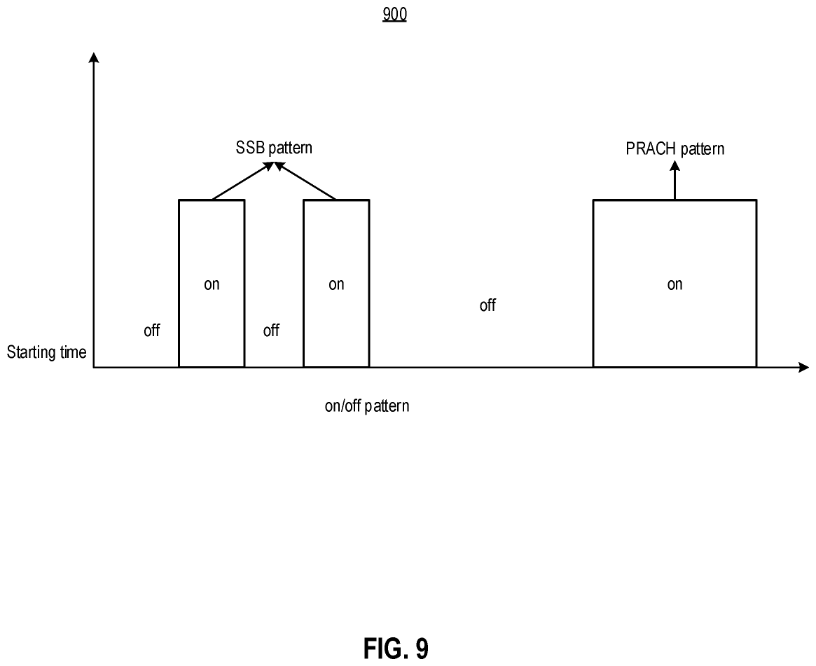

FIG. 9 illustrates an example 900 of certain options for pattern-based indication. Referring to option 7, the BS 102 can provide an explicit on/off pattern (e.g., transmission pattern included in the status indication information) indication to the SN 306. In this case, the BS 102 may determine/identify the transmission pattern (e.g., on/off pattern). Once determined, the BS 102 can directly transmit/send/provide/signal the pattern to the SN 306. Subsequently, the SN 306 can determine the on/off configuration for signal forwarding based on the pattern. For example, the BS 102 can determine the explicit on/off pattern based on at least one of a common channel pattern, serving UE's traffic, inter-cell interference level, and/or time duplexing (TDD) UL/DL pattern, among others.

For example, the common channel pattern can include at least one of synchronization signal block (SSB), control resource set (CORESET) #0, physical random access channel (PRACH), system information block (SIB) 1, and/or group common physical downlink control channel (PDCCH). Within SSB and/or CORESET #0 pattern (e.g., DL transmission), at least one of the forwarding links F2 and/or F4 can be activated. Within the SIB1 transmission pattern, at least one of the forwarding links F2 and/or F4 can be activated. Within the group common PDCCH transmission pattern, at least one of the forwarding links F2 and/or F4 can be activated. Within PRACH pattern, at least one of the forwarding links F1 and/or F3 can be activated.

In another example, the serving UE can refer to at least one of the UL transmission and/or DL reception signals of the UE can be amplified and forwarded by the SN 306. The pattern may be impacted by, based on, or according to the UE's 104 specific traffic.

In further example, inter-cell interference level may be measured by the SN 306 (or other SNs) within the cell edge or neighbor cell(s). After the association between the SN 306 and BS 102 or between the SN 306 and another SN, the BS 102 can analyze the inter-cell interference level and adjust the on/off pattern of SN 306 accordingly.

In various examples, the explicit on/off pattern can be based on TDD UL/DL pattern. For UL/DL symbol and/or slot, the SN 306 can follow a legacy repeater behavior. For example, in the UL symbol and/or slot, the forwarding links F1 and F3 can be turned off, and forwarding links F2 and F4 can be turned on. In the DL symbol and/or slot, the forwarding links F2 and F4 can be turned off, and the forwarding links F1 and F3 can be turned on.

Further, for a flexible symbol, the explicit on/off pattern can depend or be based on whether dynamic TDD is or is not supported by the SN 306. For example, if dynamic TDD is not supported, then in the flexible symbol or slot, the forwarding links F1-F4 may always be either on or off. Otherwise, if dynamic TDD is supported, the on/off status of the SN 306 can be determined by the slot format indication (SFI) in the DCI.

Referring to option 8, the BS 102 can provide an implicit on/off pattern indication to the SN 306. In this case, the BS 102 may not transmit a dedicated pattern for the SN 306. Instead, the status indication information (e.g., on/off pattern) can be implicitly determined by the common channel pattern including at least one of SSB, CORESET #0, PRACH, SIB1, group common PDCCH, among others. For example, and similar to the previous example, within SSB and/or CORESET #0 pattern (e.g., DL transmission), at least one of the forwarding links F2 and/or F4 can be activated. Within the SIB1 transmission pattern, at least one of the forwarding links F2 and/or F4 can be activated. Within the group common PDCCH transmission pattern, at least one of the forwarding links F2 and/or F4 can be activated. Within PRACH pattern, at least one of the forwarding links F1 and/or F3 can be activated.

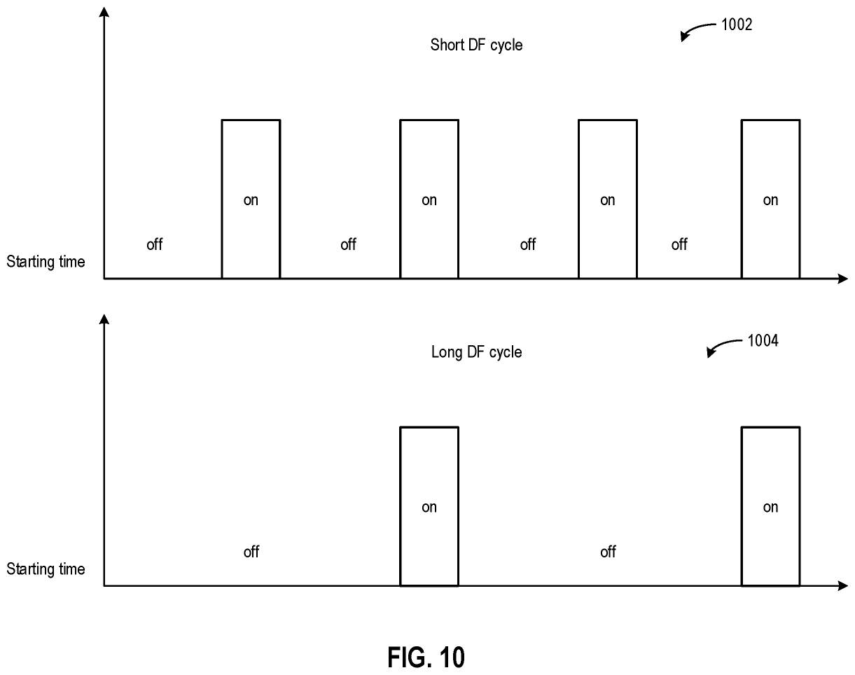

FIG. 10 illustrates an example of another option for pattern-based indication. Referring to option 9, the BS 102 can define or configure a discontinuous forwarding (DF) mode/operation/configuration for the SN FU. The DF mode can be similar to the discontinuous reception (DRX) mode (e.g., extended DRX (e-DRX) mode, power saving mode (PSM), etc.) for legacy UE. In this DF mode, the BS 102 can enable the forwarding functionality of the SN 306 discontinuously, such as for reducing energy consumption and/or alleviating interference. The BS 102 can configure the DF mode configuration via at least one of RRC, OAM signaling, MAC CE, and/or DCI.

Similar to the DF operation for legacy UE 104, the DF operation/mode can be controlled by configuring one or more of at least the following parameters (e.g., the parameters can be specified or configured in legacy DRX operation):
df-onDurationTimer: the duration at the beginning of a DF cycle;
df-SlotOffset: the delay before starting the df-onDurationTimer;
df-Inactivity Timer: the duration after the PDCCH occasion in which a PDCCH indicates a new UL and/or DL transmission for the MAC entity;
df-RetransmissionTimerDL (e.g., per DL hybrid automatic repeat request (HARQ) process except for the broadcast process): the maximum duration until a DL retransmission is received;
df-RetransmissionTimerUL (e.g., per UL HARQ process): the maximum duration until a grant or acknowledgment for UL retransmission is received;
df-LongCycleStartOffset: the long DF cycle and df-StartOffset which defines the subframe where the long and/or short DF cycle starts;
df-ShortCycle: the short DF cycle;
df-ShortCycleTimer: the duration the UE shall follow the short DF cycle;
df-HARQ-RJTT-TimerDL (e.g., per DL HARQ process except for the broadcast process): the minimum duration before a DL assignment for HARQ retransmission is expected by the MAC entity;
df-HARQ-RJTT-TimerUL (e.g., per UL HARQ process): the minimum duration before a UL HARQ retransmission grant or acknowledgment is expected by the MAC entity;
ps-Wakeup: the configuration to start the associated df-onDurationTimer in case DCI with cyclic redundancy check (CRC) scrambled by power-saving radio network temporary identity (PS-RNTI) (DCP) is monitored but not detected;
ps-TransmitOtherPeriodicCSI: the configuration to report periodic CSI that is not layer 1 (L1)-reference signal received power (RSRP) on PUCCH during the time duration indicated by df-onDurationTimer in case DCP is configured but the associated df-onDurationTimer is not started; and/or
ps-TransmitPeriodicL1-RSRP: the configuration to transmit periodic channel state information (CSI) that is L1-RSRP on PUCCH during the time duration indicated by df-onDurationTimer, in case DCP is configured but the associated df-onDurationTimer is not started.

Further, the DF pattern can be determined by at least one of the following operations/methods:
1. The DF pattern can be determined/configured by the BS 102 based on at least one of the common channel pattern, serving the traffic of the UE 104, inter-cell interference level, and/or TDD UL/DL pattern.
1A. The common channel pattern can include at least one of SSB, CORESET #0, PRACH, SIB1, and/or group common PDCCH. For example, within SSB and CORESET #0 pattern, forwarding links F2 and F4 can be turned on or enabled. Within SIB1 transmission pattern, forwarding links F2 and F4 can be turned on. Within the group common PDCCH transmission pattern, forwarding links F2 and F4 can be turned on. Within PRACH pattern, forwarding link F1 and F3 can be turned on.
1B. The serving UE can refer to at least one of the UL transmission and/or DL reception signals of the UE 104 is amplified and forwarded by the SN 306. Subsequently, the pattern may be impacted by the UE's specific traffic.
1C. The inter-cell interference level may be measured by the SN 306 (or other SNs) in cell edge or neighbor cell, after association between SN 306 and BS 102 or SN 306 and another SN 306. In this case, the BS 102 can analyze/process the inter-cell interference level and adjust the on/off pattern (e.g., the status indication information) of the SN 306.
1D. The DF pattern can be determined based on the TDD UL/DL pattern. For UL/DL symbol and/or slot, the SN 306 can follow a legacy repeater behavior. For example, in the UL symbol and/or slot, the forwarding links F1 and F3 can be turned off, and forwarding links F2 and F4 can be turned on. In the DL symbol and/or slot, the forwarding links F2 and F4 can be turned off, and the forwarding links F1 and F3 can be turned on. For a flexible symbol, the explicit on/off pattern can depend or be based on whether dynamic TDD is or is not supported by the SN 306. For example, if dynamic TDD is not supported, then in the flexible symbol or slot, the forwarding links F1-F4 may always be either on or off (e.g., maintained at the activation state or deactivation state). Otherwise, if dynamic TDD is supported, the on/off status of the SN 306 can be determined by the SFI indication in the DCI.
2. Different DF cycles may be defined in DF mode, such as long DF cycle and/or short DF cycle. As shown in FIG. 10, the short DF cycle can be associated with graph 1002, and the long DF cycle can be associated with graph 1004. For example, the long DF cycle may include a larger (e.g., longer, lengthier, or more extensive) forwarding-on duration (e.g., the duration or gap until activation of the SN 306) compared to the short DF cycle. In this case, the forwarding-on duration can refer to the duration between activation states (e.g., duration to maintain off-state). The duration of the cycle and the duration of forwarding-on of the cycle can be configurable by the BS 102 to determine different DF cycles.
3. The DF mode for the forwarding unit (e.g., discontinuous activation of the signal forwarding) may be associated with the DRX mode (or e-DRX mode or PSM) for the communication unit. For example, when the SN CU is in DRX mode (or e-DRX mode or PSM), the SN FU can be simultaneously configured with the DF mode. Accordingly, within the active time of the DRX mode of SN CU, the forwarding status can be activated/on/enabled for SN FU. Otherwise, the forwarding status may be off/deactivated/disabled, such as outside of the active time of the DRX mode of SN CU.

### Example Options for Exception Conditions

In some implementations, such as for option 10, the status indication information (e.g., on/off status) can be determined by the condition/parameter/criteria of the SN 306. For example, when the SN CU encounters/identifies/determines/observes poor link quality or is unable to forward data, the forwarding link(s) can be turned off/deactivated/disabled to alleviate potential interference. Further, when the SN CU is in one or more of at least the following conditions, the SN FU can be deactivated in the link level or SN level:
1) Before SN 306 enters/switches to RRC_CONNECTED state (e.g., the SN 306 in a state, such as idle or inactive state, prior to entering the RRC connected state): the BS 102 may not transmit side control information to the SN 306, such that the forwarding link(s) can be deactivated.
2) No qualified SSB: during SSB measurement, the RSRP of all SSBs may be under a threshold (e.g., the defined threshold for the number of re-transmissions is exceeded).
3) Random-access failure: during the random access procedure, after random access fails N times (e.g., configurable), the random access procedure can be regarded/considered/determined as random access failure.
4) Listen before talk (LBT) failure: after SN 306 performs LBT (e.g., detects whether there is a signal in the communication channel or link), but fails for N times, the LBT procedure/operation can be regarded as LBT failure.
5) Radio link failure: when the radio link is judged/determined to be in poor condition, the radio link can be regarded as a radio link failure.
6) Beam failure: when SN 306 is in beam failure detection (BFD)/beam failure recovery procedure, the SN 306 can detect/determine/identify beam failure according to RSRP measurement of reference signals, such as SSB, CSI-RS, among others.
7) The number of re-transmission exceeds N: it can be PUSCH/PUCCH.

### Example Options for One State Indication

Referring to option 11, the BS 102 can provide a one-state indication to the SN 306. The BS 102 can configure on/off or activation/deactivation state of the SN FU with the one state, either “on” or “off” state. The BS 102 can provide the one-state indication via RRC. In this case, the state may not change until an RRC re-configuration or when the SN 306 receives other dynamic signalings. For example, the state of the SN FU may be configured with an “on” state via the RRC. The SN FU may not change from the “on” state (e.g., maintain the activation state) until the RRC re-configuration or receiving the other dynamic on/off indications.

Referring to option 12, the BS 102 can provide a one-state indication with a time domain index. In this case, the on/off state (e.g., one of the activation or deactivation state) of the SN FU can be the one state by default (e.g., a default state of the SN FU). The BS 102 can configure the other state for the SN FU via RRC signaling along with a time domain index. For example, the state of the SN FU can default to an “off” state, and the “on” state can be configured via RRC along with the time domain index (e.g., at least one of frame index, sub-frame index, slot index, symbol index, and/or absolute time index (e.g., s, ms, etc.), among others). Within the configured time domain duration, the SN FU can remain or maintain the activation state. Otherwise, such as outside of the time-domain duration, the SN FU can be deactivated or transition back to the default state (e.g., off state in this example).

### Example Options for Beam Indication Association

In some implementations, referring to option 13, the BS 102 can send/transmit a beam indication indicating an implicit determination to the SN 306. When SN FU is in a first state (e.g., deactivation state) and the SN CU receives beam indication, with or without time duration, the beam indication can imply or indicate that the SN FU should be switched to a second state opposite the first state (e.g., activation state). Subsequently, based on the implicit determination, the SN FU can enter the second state.

For example, when the SN FU is “off” or deactivated and the SN CU receives the beam indication with time duration from the BS 102, the beam indication can implicitly indicate that the SN FU should be activated or turned on. Subsequently, the SN FU can be turned on within or for the provided time duration, and changed or reverted back to an “off” or deactivation state after the time duration.

In another example, when the SN FU is “off” and SN CU receives the beam indication with time duration, the beam indication can imply that the SN FU should be turned on. Subsequently, the SN FU can be activated responsive to receiving the indication, maintain the activation state for the time duration, and revert back to the deactivation state after the time duration (e.g., expiry of the time duration).

In further example, while the SN FU is deactivated and SN CU receives the beam indication without time duration, the beam indication can imply that the SN FU should be turned on. Subsequently, the SN FU can be activated and maintain the “on” state for at least the predefined time duration, such as 1 slot, 1 sub-frame, 1 frame, or 1 symbol.

### EXAMPLES OF COMBINATION(S) OF OPTIONS

### Example 1

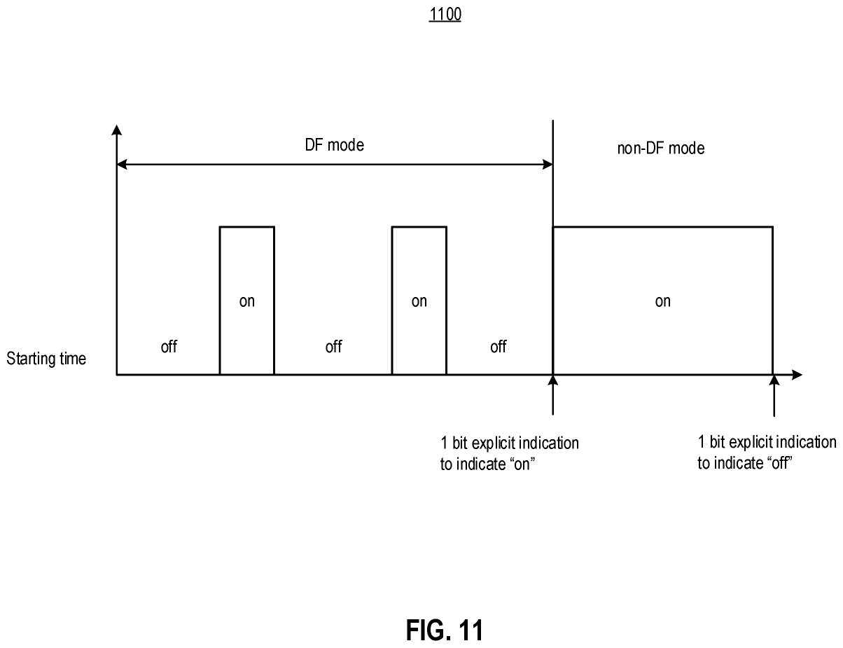

FIG. 11 illustrates an example 1100 of a combination of options 1 and 9 for the on/off indication. As discussed herein, the one or more options can be jointly used (e.g., joint configuration) for configuring the activation or deactivation state of the SN 306, such as the combination of options 1 and 9.

For example, as shown in FIG. 11, when the SN FU is in DF mode, if the SN CU receives a 1-bit explicit indication (e.g., option 1), e.g., 1-bit “on”, the SN FU can be changed from the DF mode to a non-DF mode. Subsequently, if the SN FU is activated when receiving the indication (e.g., activation indication), the SN FU can maintain the “on” status until the SN 306 receives another (e.g., different) indication to change the on/off status. Otherwise, if the SN FU is off when receiving the indication (e.g., activation indication), the SN FU can be activated. The SN FU can remain on (e.g., maintained the activation state) until the SN 306 receives another indication to change the on/off status.

### Example 2

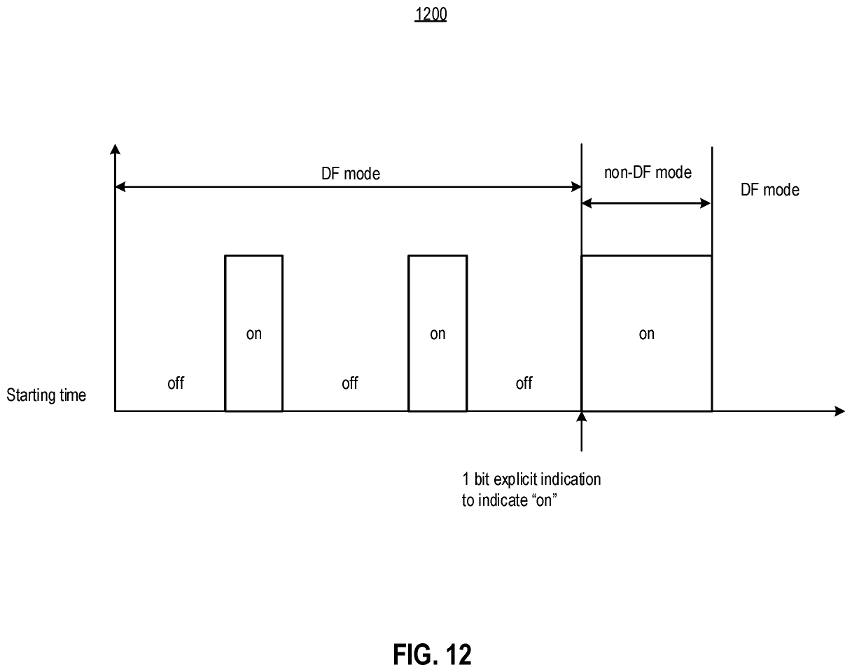

FIG. 12 illustrates an example 1200 of a combination of options 3 and 9 for the on/off indication. In various implementations, the combination of options 3 and 9 can be used as the joint configuration. For example, when the SN FU is in DF mode, once the SN 306 receives a 1-bit explicit indication and a duration (e.g., option 3), e.g., 1 bit “on”, the SN FU can be changed from the DF mode to non-DF mode in/during that duration provided by the BS 102. After the end of the duration, the SN FU can be changed back from the non-DF mode to the DF mode (e.g., or vice versa depending on the configuration). In this case, if the SN FU is activated when receiving the indication, the SN FU can maintain the activation state for the specified time duration. After the duration time, the status of SN FU can be determined by the DF mode pattern. Otherwise, if the SN FU is deactivated when receiving the indication, the SN FU can be activated. The SN FU can maintain the activation state for the time duration. After the time duration (e.g., expiry of the duration), the status of the SN FU can be determined by the DF mode pattern.

The joint configuration using options 1 and 9 and options 3 and 9 are provided for the purposes of examples. Other combinations using the options discussed herein (among other options) can be used for the joint configuration to configure the on/off indication for the SN 306. For instance, based on options 8 and 9, when the SN 306 is in DF mode, and the BS 102 configures the implicit determination of the common channel, the two patterns (e.g., from options 8 and 9) may be combined and the common channel pattern may include a higher priority. For instance, the SN 306 may be kept/maintained within the common channel duration.

### Example 3

In some implementations, the combination of options 1 and 11 can be used for on/off status configuration. For example, the state of SN FU can be configured with an activation state via RRC by the BS 102. When the SN 306 receives a 1-bit explicit indication (e.g., “off” state) via at least one of DCI and/or MAC CE, the state of SN FU can be changed to a deactivation state until the RRC signaling is re-configured/modified (e.g., resend to the SN 306) or until the SN 306 receives another dynamic on/off indication (e.g., opposite to the deactivation state). In another example, through the RRC, th estate of the SN FU can be configured with an “off” state. In this case, when the SN 306 receives a 1-bit explicit indication from the BS 102 (e.g., an indication for an “on” state) via at least one of DCI and/or MAC CE, the state of the SN FU can be modified to activation state. The SN FU can maintain the activation state until the RRC is re-configured or until the SN 306 receives another dynamic on/off indication (e.g., opposite to the activation state).

### Example 4

In some cases, options 1 and 12 can be combined for on/off configuration. For example, the state of the SN FU can default to “off”, and the “on” state can be configured via RRC along with a time-domain index (e.g., at least one of frame index, sub-frame index, slot index, and/or symbol index). Within the configured time-domain index/duration, the SN FU can be in the activation state. Otherwise, the SN FU can remain at the default state or the deactivation state in this case. During the period when the SN FU is in the “off” state, the state can be changed by a 1-bit explicit on/off indication (e.g., “on” state) via at least one of the DCI and/or MAC CE.

### Example 5

In some aspects, options 2 and 12 can be combined for the on/off configuration. For example, the state of the SN FU can default to “off”, and the “on” state can be configured via RRC along with a time-domain index (e.g., frame index, sub-frame index, slot index, symbol index, and/or absolute time index (e.g., s, ms, etc.)). During the configured time-domain duration/index, the SN FU can be in the activation state. Otherwise, the SN FU can be in the deactivation state or default state. During the “off” period or while the SN FU is in the deactivation state, the state can be changed by a 1-bit implicit indication (e.g., “on”) configured via DCI, for example.

### Example 6

In various implementations, options 3 and 12 can be combined for on/off configuration. For example, the state of the SN FU can default to an “off” state, and the “on” state can be configured via RRC along with a time-domain index (e.g., at least one of frame index, sub-frame index, slot index, symbol index, and/or absolute time index (e.g., s, ms, etc.)). Within the configured time-domain duration/index, the SN FU can be in an activation state. Otherwise, the SN FU can be in a deactivation state outside of the time-domain duration. During the “off” or deactivation period, the state can be changed to “on” for a duration by a 1-bit explicit on/off indication (e.g., “on”) via at least one of DCI and/or MAC CE with a duration via RRC, OAM signaling, MAC CE, and/or DCI.

### Example 7

In some embodiments, options 1 and 7 can be combined for on/off configuration/indication. For example, when the SN FU is configured with a pattern, if the SN CU receives a 1-bit explicit indication, such as 1 bit “on”, the pattern may not be applied on SN FU. In some cases, if the SN FU is in the activation state when receiving the indication, the SN FU can maintain the activation status/state until the SN 306 receives an indication to change the on/off status (e.g., an indication of a state opposite to the previous state). Otherwise, if the SN FU is in the deactivation state when receiving the indication, the SN FU can be activated. The SN FU can maintain or remain in the activation state until the SN 306 receives another indication to change the on/off status.

### Example 8

In various aspects, options 3 and 7 can be combined for the on/off configuration. For example, when the SN FU is configured with a pattern, if the SN CU receives a 1-bit explicit indication, such as 1 bit “on” indication, the pattern may not be applied on the SN FU within the (e.g., predetermined/specified) duration. The SN FU can reuse the pattern after expiry of or the end of the duration. In some cases, if the SN FU is on when receiving the indication, the SN FU can maintain the activation state for the duration of time. After this duration, the state/status of the SN FU can be determined based on the configured pattern. In some other cases, if the SN FU is off when receiving the indication, the SN FU can be activated. The SN FU can maintain the activation state for the time duration. After the time duration, the state of SN FU can be determined based on the configured pattern.

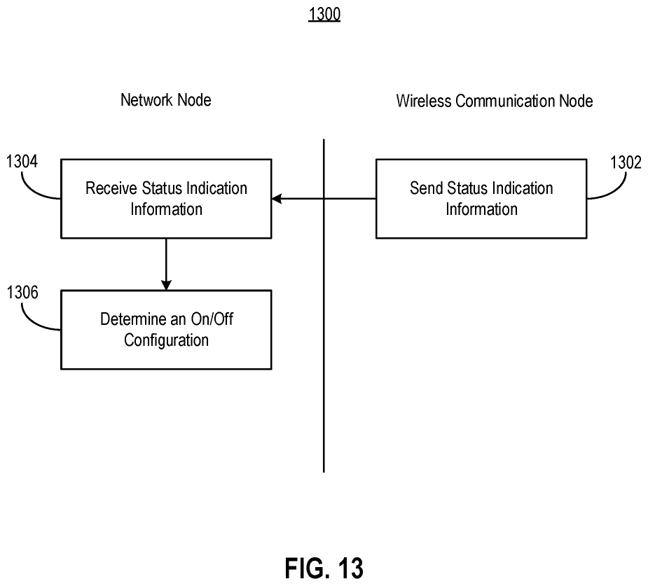

Referring now to FIG. 13 illustrates a flow diagram of a method 1300 for on/off status control for network nodes. The method 1300 may be implemented using any of the components and devices detailed herein in conjunction with FIGS. 1-12. In overview, the method 1300 may include sending status indication information (1302). The method 1300 can include receiving status indication information (1304). The method 1300 can include determining an on/off configuration (1306).

Referring now to operation (1302), and in some implementations, a wireless communication node (e.g., BS or gNB) can send/transmit/provide status indication information (e.g., on/off indication) to a network node (e.g., SN). By transmitting the status indication information, the BS 102 can cause the network node to determine an on/off configuration (e.g., corresponding to a forwarding link and/or a forwarding functionality) of the network node to support signal forwarding of one or more signals between the wireless communication node and a wireless communication device (e.g., UE).

Referring now to operation (1304), and in some implementations, the network node can receive status indication information from the wireless communication node. For example, the network node can receive the status indication information from the wireless communication node via a signaling comprising at least one of: downlink control information (DCI) or medium access control control element (MAC CE) signaling, radio resource control (RRC), and/or operations, administration and maintenance (OAM) signaling.

In some implementations, the network node can send/transmit/respond to the wireless communication node in response to receiving the status indication information. For example, the network node can transmit a hybrid automatic repeat request acknowledgment (HARQ-ACK) feedback message, in response to receiving the status indication information. The feedback behavior of the network node can correspond to a functionality controlled by (e.g., feedback functionality configured by) the wireless communication node. The functionality can be based on the network node capability report. For example, the status indication information can be carried in the MAC CE and/or RRC via PDSCH, and the corresponding feedback can be HARQ-ACK message via PUCCH/PUSCH. In another example, the status indication information can be carried in the DCI via PDCCH, and the corresponding feedback can be HARQ-ACK message via PUCCH. In yet another example, the status indication information can be carried in the DCI via PDCCH, and the corresponding feedback can be HARQ-ACK message via PUSCH.

Referring now to operation (1306), and in some implementations, the network node can determine an on/off configuration of the network node, according to the status indication information, to support signal forwarding of one or more signals between the wireless communication node and the wireless communication device.

In some implementations, the on/off configuration can include at least one of: an on/off configuration of the network node; an on/off configuration of a group of network nodes; an on/off configuration of one or more antenna ports of the network node; an on/off configuration of one or more beam indexes of the network node; an on/off configuration of one or more serving sectors of the network node; and/or an on/off configuration of one or more components of the network node. In various implementations, the on/off configuration may include the on/off configuration of at least one of the following links: a first communication link from a wireless communication node to the network node (e.g., C2 link); a second communication link from the network node to the wireless communication node (e.g., C1 link); a first forwarding link from the wireless communication node to the network node (e.g., F2 link); a second forwarding link from the network node to the wireless communication node (e.g., F1 link); a third forwarding link from the network node to the wireless communication device (e.g., F4 link); and/or a fourth forwarding link from the wireless communication device to the network node (e.g., F3 link).

In some cases, the on/off configuration of the network node can become active at a time instance (e.g., epoch time). The time instance can include at least one of: a starting time of a next sub-frame; an end of a sub-frame in which the network node receives the status indication information; a starting time of a next frame; an end of a frame in which the network node receives the status indication information; a starting time of a sub-frame indicated by a system frame number (SFN) that is signaled together with the status indication information; a starting time of a frame indicated by a SFN that is signaled together with the status indication information; an end of system information (SI) window; a time instance at a defined duration (e.g., defined in standards, in units of symbol, slot, or ms) after the network node receives the status indication information; a time instance at a first duration after the network node receives the status indication information, where the first duration can be based on the network node's capability; and/or a time instance at a second duration after the network node receives the status indication information, where the second duration can be configured via a signaling (e.g., at least one of OAM signaling, RRC, MAC CE and/or DCI) from the wireless communication node.

In some implementations, the status indication information can include a 1-bit indication (e.g., options 1 and/or 3). The 1-bit indication can include/have a first value (e.g., bit 1) that indicates to activate the signal forwarding, or a second value (e.g., bit 0) that indicates to deactivate the signal forwarding. In some cases, a state of activation or deactivation of the signal forwarding can be maintained until a next 1-bit indication indicating a different state (e.g., different state from the state of activation or deactivation). In certain aspects, at least one of: a state of activation or deactivation of the signal forwarding can be configured to change to a previous state after a defined time has elapsed, or the defined duration (e.g., in units of symbol, slot, or ms) can be configured via a DCI, MAC CE, radio resource control (RRC) or operations, administration and maintenance (OAM) signaling.

In certain implementations, at least one of: the status indication information can include a value related to the transmission power control of the network node, if the value is at least one of: equal to or greater than a defined value, the value can indicate to activate the signal forwarding, or to deactivate the signal forwarding, and/or if the cumulated value related to the transmission power control of the network node by applying the value in status indication information is at least one of: equal to and/or greater than a defined value, the value or the cumulated value can indicate to activate the signal forwarding, or to deactivate the signal forwarding (e.g., option 2). In some cases, the defined value can be configured via a radio resource control (RRC), MAC CE, or operations, administration and maintenance (OAM) signaling. In some aspects, the value can be indicated by the transmit power control (TPC) field in a downlink control information (DCI) field.

In some implementations, a state of activation or deactivation of the signal can be configured to change to a previous state after a defined time (e.g., predetermined duration) has elapsed, and/or the defined duration (e.g., in units of symbol, slot, or ms) can be configured via a downlink control information (DCI), medium access control control element (MAC CE), RRC or OAM signaling (e.g., option 4).

In some aspects, the status indication information can comprise at least one of: a duration indicating a first duration to activate the signal forwarding or to deactivate the signal forwarding, and/or a periodicity indicating to alternate between the first duration, and a second duration with a state of activation or deactivation of signal forwarding that is opposite that of the first duration, over time (e.g., option 5). In some implementations, the status indication information can comprise at least one of: a ratio or percentage indicating a first duration to activate the signal forwarding and a second duration to deactivate the signal forwarding, and/or a periodicity indicating to alternate between the first duration and the second duration over time (e.g., option 6). The periodicity can be activated at a reference time, or at the time instance according to at least one certain time instance (e.g., epoch time).

In some cases, the status indication information can include a transmission pattern (e.g., option 7). For example, the network node can receive/obtain/identify the transmission pattern from the wireless communication node. The pattern can be determined based on the common channel, configurable by the wireless communication node. Further, the pattern may also be based on at least one of the serving traffic of the wireless communication device (e.g., UE), inter-cell interference level, among others.

In certain aspects, the on/off configuration can be implicitly determined by a transmission pattern of at least one of a common signal and/or a common channel (e.g., option 8). For example, the wireless communication node can transmit/provide/send the common channel or signal to the network node. Subsequently, the network node can determine the on/off pattern based on the common channel. The status indication can be the enabler of the implicit determination. In some embodiments, the implicit determination may be included in the status indication information or specified directly in the specification. In some cases, the status indication information can comprise the implicit determination.

In some implementations, referring to the implicit determination of the on/off configuration, at least one of: within a transmission pattern of a synchronization signal block (SSB) or a control resource set (CORESET) #0, at least one forwarding link can be activated; within a transmission pattern of a system information block (SIB) #1, at least one forwarding link can be activated; within a transmission pattern of a group common physical downlink control channel (PDCCH), at least one forwarding link can be activated; and/or within a transmission pattern of a physical random access channel (PRACH), at least one forwarding link can be activated. In certain cases, the on/off configuration may be associated with a discontinuous reception mode.

In various implementations, the status indication information can indicate a mode of discontinuous activation (e.g., discontinuous forwarding (DF)) of the signal forwarding. At least one of: a duration of a cycle (and/or a forwarding-on duration of a cycle) for the mode of discontinuous activation of the signal forwarding (e.g., DF), or a duration of an on state or an off state of the signal forwarding, can be configurable (e.g., by the wireless communication node). In some cases, the mode of discontinuous activation of the signal forwarding (e.g., DF) can be associated with a discontinuous reception mode.

In some implementations, the network node can receive a 1-bit indication when the network node is operating under the mode of discontinuous activation of the signal forwarding (e.g., DF). The network node can determine, according to the 1-bit indication, to exit the mode of discontinuous activation of the signal forwarding (e.g., DF). In some cases, at least one of: if the network node is supporting the signal forwarding when the 1-bit indication is received, the network node can continue to support the signal forwarding at least until a next 1-bit indication is received, and/or if the network node is not supporting the signal forwarding when the 1-bit indication is received, the network node can activate/enable the signal forwarding at least until a next 1-bit indication is received (e.g., a combination of options 1 and 9).

In some embodiments, the network node may receive a 1-bit indication and a duration when the network node is operating under the mode of discontinuous activation of the signal forwarding (e.g., DF). In this case, the network node can determine, according to the 1-bit indication, to exit the mode of discontinuous activation of the signal forwarding (e.g., DF) in the duration. Further, the network node can resume the mode of discontinuous activation of the signal forwarding (e.g., DF) when the duration ends (e.g., a combination of options 3 and 9). In certain aspects, at least one of: if the network node is supporting the signal forwarding when the 1-bit indication is received, the network node can continue to support the signal forwarding for the duration, and resume the mode of discontinuous activation of the signal forwarding (e.g., DF) when the duration ends, and/or if the network node is not supporting the signal forwarding when the 1-bit indication is received, the network node can activate the signal forwarding for the duration, and resume the mode of discontinuous activation of the signal forwarding (e.g., DF) when the duration ends.

In various implementations, the wireless communication node can determine, according to a condition of the network node, an on/off configuration (e.g., corresponding to a forwarding link and/or a forwarding functionality) of the network node to support signal forwarding of one or more signals between the wireless communication node and a wireless communication device. In certain implementations, the condition of the network node can comprise at least one of: the network node is in a state prior to entering a radio resource control (RRC) connected state, the network node in a RRC idle or inactive state, unavailability of a qualified synchronization signal block (SSB), a random access failure, a look-before-talk failure, a radio link failure, a beam failure, and/or a defined threshold for number of re-transmissions is exceeded.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a smart node (SN) communication unit (CU) of a smart node, from a base station (BS), a beam indication with a time duration, the beam indication indicating to activate a SN forwarding unit (FU) of the SN to an on state; and
maintaining the SN FU in the on state over the time duration.

2. The method of claim 1, comprising:
deactivating the SN FU to an off state when outside of the time duration.

3. The method of claim 1, wherein the time duration corresponds to symbol level.

4. The method of claim 1, wherein the beam indication with the time duration is received from the BS via at least one of radio resource control (RRC) signaling or downlink control information (DCI) signaling.

5. The method of claim 2, wherein deactivating the SN FU to the off state when outside of the time duration comprises disabling the transmitting and receiving operations of the SN FU when outside of the time duration.

6. The method of claim 1, wherein maintaining the SN FU in the on state over the time duration comprises enabling signal forwarding of the SN FU until the SN FU is deactivated to the off state.

7. The method of claim 1, wherein in response to the SN being in a radio resource control (RRC) idle state, deactivating the SN FU to an off state.

8. The method of claim 1, wherein the SN comprises a network controlled repeater, and the SN CU comprises a mobile terminal (MT).

9. A smart node (SN) communication unit (CU) of a SN, comprising:
at least one processor configured to:
receive, via a receiver from a base station (BS), a beam indication with a time duration, the beam indication indicating to activate a SN forwarding unit (FU) of the SN to an on state; and
maintain the SN FU in the on state over the time duration.

10. The SN CU of claim 9, wherein the at least one processor is configured to:
deactivate the SN FU to an off state when outside of the time duration.

11. The SN CU of claim 9, wherein the time duration corresponds to symbol level.

12. The SN CU of claim 9, wherein the beam indication with the time duration is received from the BS via at least one of radio resource control (RRC) signaling or downlink control information (DCI) signaling.

13. The SN CU of claim 10, wherein to deactivate the SN FU to an off state when outside of the time duration, the at least one processor is configured to disable the transmitting and receiving operations of the SN FU when outside of the time duration.

14. The SN CU of claim 9, wherein to maintain the SN FU in the on state over the time duration, the at least one processor is configured to enable signal forwarding of the SN FU until the SN FU is deactivated to the off state.

15. The SN CU of claim 9, wherein in response to the SN being in a radio resource control (RRC) idle state, deactivating the SN FU to an off state.

16. The SN CU of claim 9, wherein the SN comprises a network controlled repeater, and the SN CU comprises a mobile terminal (MT).

17. Abase station, comprising:
at least one processor configured to:
send, via a transmitter to a smart node (SN) communication unit (CU) of a SN, a beam indication with a time duration, the beam indication indicating to activate a SN forwarding unit (FU) of the SN to an on state,
wherein the SN FU is maintained in the on state over the time duration.

18. The SN CU of claim 17, wherein the SN FU is deactivated to an off state when outside of the time duration.

19. The SN CU of claim 17, wherein the time duration corresponds to symbol level.

20. The SN CU of claim 17, wherein the SN comprises a network controlled repeater, and the SN CU comprises a mobile terminal (MT).
